(19) United States
(12) Patent Application Publication
(10) Pub. No.: US 2024/0070229 A1
(43) Pub. Date: Feb. 29, 2024

(54) COMPUTER-READABLE RECORDING MEDIUM STORING DATA AUGMENTATION PROGRAM, DATA AUGMENTATION METHOD, AND DATA AUGMENTATION APPARATUS

(71) Applicant: Fujitsu Limited, Kawasaki-shi (JP)

(72) Inventor: Hidekazu TAKAHASHI, Kawasaki (JP)

(73) Assignee: Fujitsu Limited, Kawasaki-shi (JP)

(21) Appl. No.: 18/342,083

(22) Filed: Jun. 27, 2023

(30) Foreign Application Priority Data
Aug. 31, 2022 (JP) 2022-137848

(51) Int. Cl. G06F 17/18

(52) U.S. Cl. CPC G06F 17/18

(57) ABSTRACT

A non-transitory computer-readable recording medium stores a data augmentation program for causing a computer to execute processing including: acquiring a first plurality of pieces of data and statistical information regarding a plurality of attributes included in each of the first plurality of pieces of data; specifying a relationship between the attributes in the first plurality of pieces of data based on values of the plurality of attributes included in each of the first plurality of pieces of data; and generating data based on the first plurality of pieces of data, the statistical information, and the relationship between the attributes in the first plurality of pieces of data.

### CROSS-REFERENCE TO RELATED APPLICATION

This application is based upon and claims the benefit of priority of the prior Japanese Patent Application No. 2022-137848, filed on Aug. 31, 2022, the entire contents of which are incorporated herein by reference.

### FIELD

The embodiment discussed herein is related to a data augmentation program, a data augmentation method, and a data augmentation apparatus.

### BACKGROUND

In a machine learning system such as deep learning, it is needed to prepare high-quality and sufficient amount of training data to be used for training of a machine learning model.

International Publication Pamphlet No. WO 2018/220700 and U.S. Patent Application Publication No. 2015/0088791 are disclosed as related art.

### SUMMARY

According to an aspect of the embodiments, a non-transitory computer-readable recording medium stores a data augmentation program for causing a computer to execute processing including: acquiring a first plurality of pieces of data and statistical information regarding a plurality of attributes included in each of the first plurality of pieces of data; specifying a relationship between the attributes in the first plurality of pieces of data based on values of the plurality of attributes included in each of the first plurality of pieces of data; and generating data based on the first plurality of pieces of data, the statistical information, and the relationship between the attributes in the first plurality of pieces of data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of a data augmentation apparatus as an example of an embodiment;

FIG. 2 is a diagram exemplifying existing data handled in the data augmentation apparatus as an example of the embodiment;

FIGS. 3A to 3D are diagrams exemplifying external statistical information handled in the data augmentation apparatus as an example of the embodiment;

FIG. 4 is a block diagram illustrating an example of a hardware configuration of a computer that implements functions of the data augmentation apparatus according to one embodiment;

FIG. 5 is a diagram for describing processing of a base artificial data generation unit of the data augmentation apparatus as an example of the embodiment;

FIG. 6 is a diagram for describing the processing of the base artificial data generation unit of the data augmentation apparatus as an example of the embodiment;

FIG. 7 is a diagram for describing the processing of the base artificial data generation unit of the data augmentation apparatus as an example of the embodiment;

FIG. 8 is a diagram for describing the processing of the base artificial data generation unit of the data augmentation apparatus as an example of the embodiment;

FIG. 9 is a diagram for describing processing of a collation unit of the data augmentation apparatus as an example of the embodiment;

FIGS. 10A and 10B are diagrams for describing processing of a data tendency extraction unit in the data augmentation apparatus as an example of the embodiment;

FIG. 11 is a diagram for describing a method of optimizing base artificial data by an artificial data optimization unit of the data augmentation apparatus as an example of the embodiment;

FIG. 12 is a diagram for describing processing of the artificial data optimization unit of the data augmentation apparatus as an example of the embodiment;

FIG. 13 is a flowchart for describing processing of the data augmentation apparatus as an example of the embodiment;

FIG. 14 is a diagram exemplifying table format data;

FIG. 15 is a diagram illustrating a data distribution example; and

FIG. 16 is a diagram exemplifying the table format data to which data generated by an existing data augmentation method is added.

### DESCRIPTION OF EMBODIMENTS

As the training data, for example, table format data may be used.

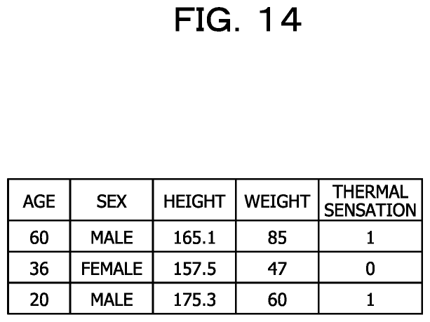

FIG. 14 is a diagram exemplifying the table format data.

Each entry of the table format data illustrated in FIG. 14 corresponds to each subject. In the example illustrated in FIG. 14, the table format data is data indicating thermal sensation in an office at a temperature of 24° C., in which a combination of age, sex, height, and weight of a subject is associated with thermal sensation of the subject. The thermal sensation is a value obtained by numerically expressing thermal sensation (hot/cold) felt by the subject, and is represented by a value in a range of −3 (cold) to +3 (hot).

In a case where such table format data is used as training data, the number of pieces of data may be reduced in a specific value or range. A value or range of certain data may be referred to as a class. Furthermore, a class having a large number of pieces of data may be referred to as a majority group class, and a class having a small number of pieces of data may be referred to as a minority group class.

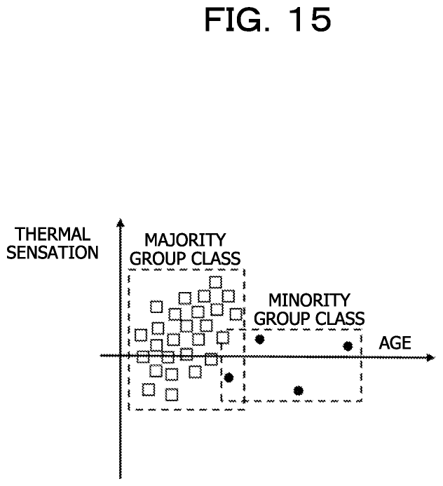

FIG. 15 is a diagram illustrating a data distribution example, and illustrates a correspondence between age and thermal sensation as a distribution diagram with respect to data indicating thermal sensation as exemplified in FIG. 14.

In the example illustrated in this FIG. 15, an older age group corresponds to the minority group class having the small number of pieces of data, and a younger age group corresponds to the majority group class having the large number of pieces of data. The majority group class may be referred to as a major class, and the minority group class may be referred to as a minority class.

In order to prepare a sufficient amount of training data, it is desirable to generate data belonging to the minority group class.

As one of methods of generating data, data augmentation is known.

As the data augmentation method, for example, interpolation and extrapolation are known. The interpolation and the extrapolation are technologies for augmenting a data set by obtaining estimated data in a case where there is no data of a desired value in the data set.

The interpolation is a method of obtaining a distribution and a tendency from existing data and obtaining estimated data in the distribution. The interpolation may be referred to as interpolation of data. On the other hand, the extrapolation is a method of estimating data outside the distribution on the assumption that the distribution and the tendency obtained from the existing data are valid even outside the distribution. The extrapolation may be referred to as extrapolation of data.

Furthermore, synthetic data augmentation for tabular data (SMOTE) is known as another data augmentation method. In the SMOTE, data is interpolated in a pseudo manner by using the k-nearest neighbor algorithm (KNN) from existing minority group data.

However, in such existing data augmentation methods, unnatural data may be generated as a result of artificially generating an attribute value of data.

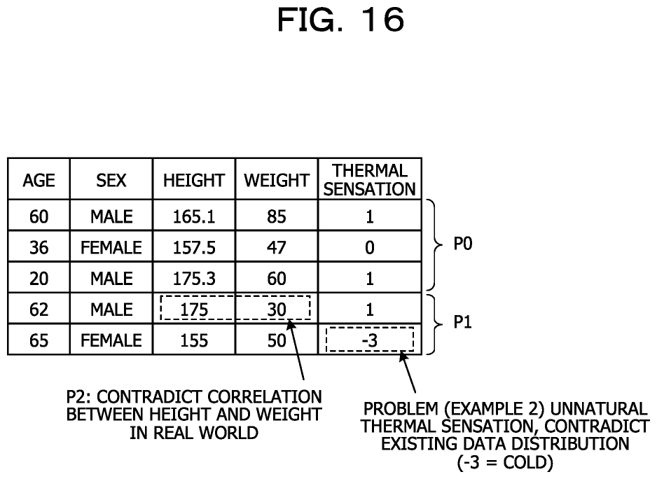

FIG. 16 is a diagram exemplifying the table format data to which data generated by an existing data augmentation method is added.

In this FIG. 16, the data generated by the existing data augmentation method (see a reference sign P1) is added to the table format data (see a reference sign P0) illustrated in FIG. 14.

In the data artificially generated by the existing data augmentation method, for example, a value contradicting a correlation between a height and a weight in the real world, such as a weight of 30 kg for a height of 175 cm, may be generated (see a reference sign P2).

Furthermore, for example, for thermal sensation having a normal data distribution range of −1 to +1, a contradictory value such as −3 may be generated (see a reference sign P3).

In this way, in the existing data augmentation method, for example, unnatural data may be generated, such as an attribute value contradicting a correlation between attribute values or an attribute value contradicting an existing data distribution.

In one aspect, an object of an embodiment is to suppress generation of unnatural data when data augmentation is performed.

Hereinafter, an embodiment according to the present data augmentation program, data augmentation method, and data augmentation apparatus will be described with reference to the drawings. Note that the embodiment to be described below is merely an example, and there is no intention to exclude application of various modifications and technologies not explicitly described in the embodiment. For example, the present embodiment may be variously modified and performed in a range without departing from the spirit thereof. Furthermore, each drawing is not intended to include only components illustrated in the drawings, and may include another function and the like.

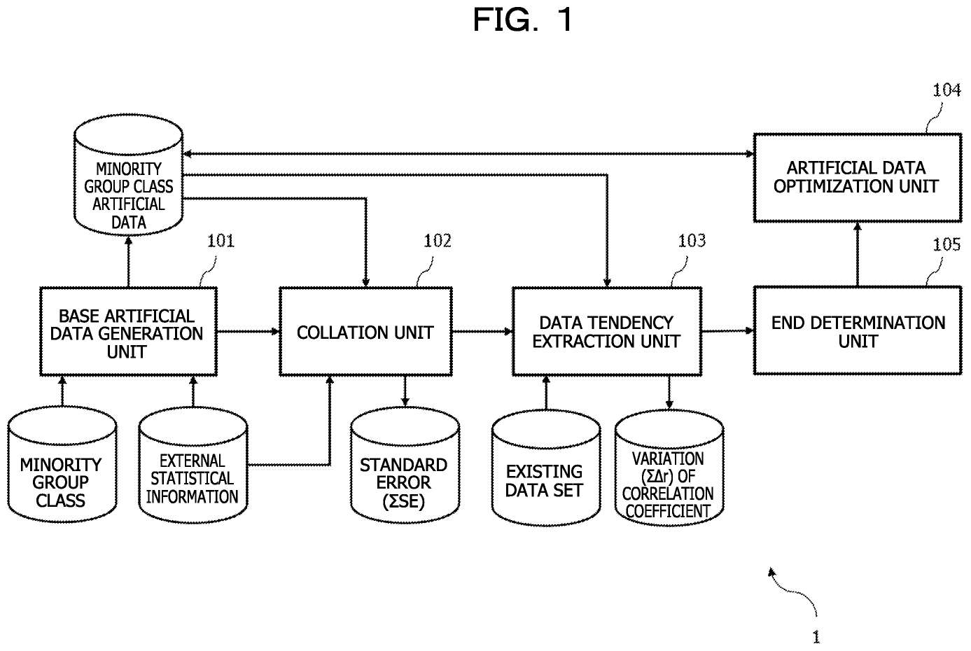

FIG. 1 is a diagram illustrating a functional configuration of a data augmentation apparatus 1 as an example of the embodiment.

The data augmentation apparatus 1 implements data augmentation by generating artificial data (augmentation data, second data) based on a plurality of pieces of existing data (first plurality of pieces of data). The data augmentation apparatus 1 generates artificial data belonging to a minority group class.

The existing data may be used as training data of a machine learning model.

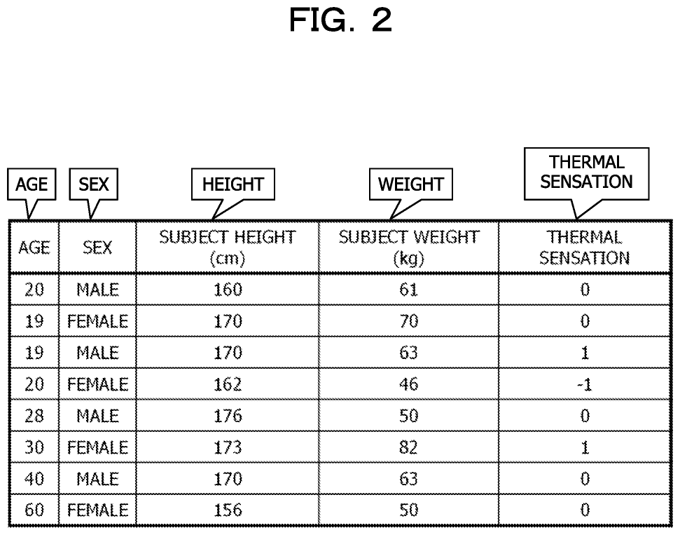

FIG. 2 is a diagram exemplifying the existing data handled in the data augmentation apparatus 1 as an example of the embodiment.

The existing data illustrated in FIG. 2 is data indicating thermal sensation of subjects in an office at a temperature of 24° C., and is table format data in which data of a plurality of attributes is combined. In the table format data exemplified in FIG. 2, combinations of age (Age), sex (Sex), height (Subject height), and weight (Subject weight) of the subjects are associated with thermal sensation of the subjects.

There may be some kind of relationship between the plurality of attributes included in the table format data. For example, there is normally a correlation between the height and the weight. The table format data may be said to be data including a relationship between the attributes.

The thermal sensation is a value obtained by numerically expressing thermal sensation (hot/cold) felt by the subject, and is represented by a value in a range of −3 (cold) to +3 (hot).

The data augmentation apparatus 1 generates the artificial data based on the existing data and external statistical information. The external statistical information is statistical information regarding the attributes included in the existing data, and is statistical information generated outside the present data augmentation apparatus 1.

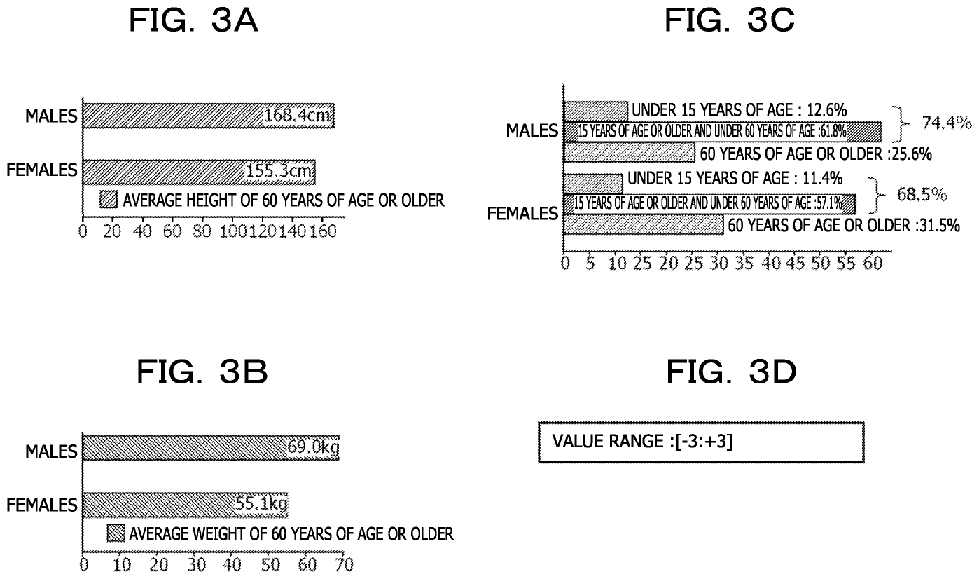

FIGS. 3A to 3D are diagrams exemplifying the external statistical information handled in the data augmentation apparatus 1 as an example of the embodiment.

In this FIGS. 3A to 3D, four pieces of external statistical information are illustrated. FIG. 3A is external statistical information regarding the height, and includes an average height (μ₁₁ cm) and variance (μ₁₁) of males 60 years of age or older and an average height (μ₁₂ cm) and variance (μ₁₂) of females 60 years of age or older.

FIG. 3B is external statistical information regarding the weight, and includes an average weight (μ₂₁ kg) and variance (μ₂₁) of males 60 years of age or older and an average weight (μ₂₂ kg) and variance (μ₂₂) of females 60 years of age or older.

FIG. 3C is external statistical information regarding the population distribution, and indicates a population distribution for each age group (under 15 years of age/15 years of age or older and under 60 years of age/60 years of age or older) of males and females. FIG. 3D is external statistical information regarding the thermal sensation, and indicates a possible range of a value of the thermal sensation.

The data augmentation apparatus 1 according to one embodiment may be a virtual server (virtual machine (VM)) or a physical server. Furthermore, the functions of the data augmentation apparatus 1 may be implemented by one computer or may be implemented by two or more computers. Moreover, at least some of the functions of the data augmentation apparatus 1 may be implemented by using hardware (HW) resources and network (NW) resources provided by a cloud environment.

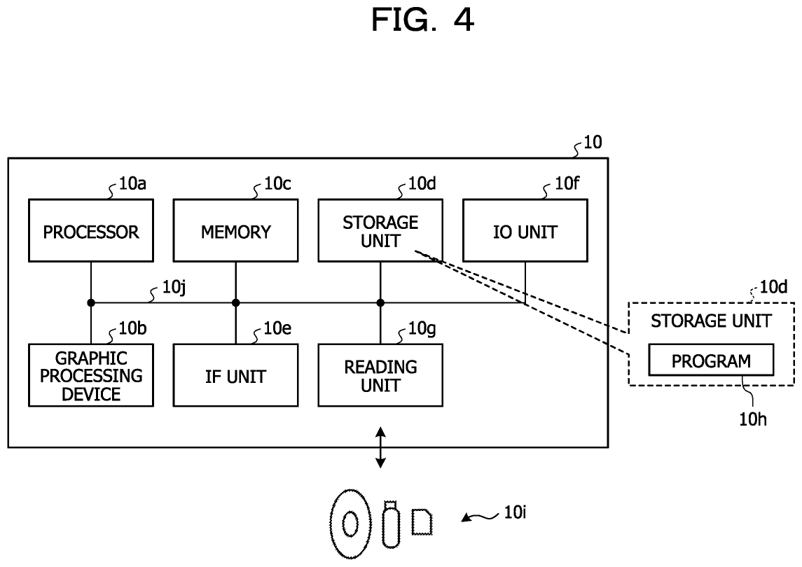

FIG. 4 is a block diagram illustrating an example of a hardware (HW) configuration of a computer 10 that implements the functions of the data augmentation apparatus 1 according to one embodiment. In a case where a plurality of computers is used as the HW resources that implement the functions of the data augmentation apparatus 1, each computer may have the HW configuration exemplified in FIG. 4.

As illustrated in FIG. 4, the computer 10 may include, for example, a processor 10a, a graphic processing device 10b, a memory 10c, a storage unit 10d, an interface (IF) unit 10e, an input/output (IO) unit 10f, and a reading unit 10g as the HW configuration.

The processor 10a is an example of an arithmetic processing device that performs various types of control and calculation. The processor 10a may be coupled to each block in the computer 10 via a bus 10j so as to be able to communicate with each other. Note that the processor 10a may be a multi-processor including a plurality of processors, or a multi-core processor including a plurality of processor cores, or may have a configuration including a plurality of multi-core processors.

As the processor 10a, for example, an integrated circuit (IC) such as a CPU, an MPU, an APU, a DSP, an ASIC, or an FPGA is exemplified. Note that a combination of two or more of these integrated circuits may be used as the processor 10a. The CPU is an abbreviation for a central processing unit, and the MPU is an abbreviation for a micro processing unit. The APU is an abbreviation for an accelerated processing unit. The DSP is an abbreviation for a digital signal processor, the ASIC is an abbreviation for an application specific IC, and the FPGA is an abbreviation for a field-programmable gate array.

The graphic processing device 10b performs screen display control on an output device such as a monitor in the IO unit 10f. Furthermore, the graphic processing device 10b may have a configuration as an accelerator that executes machine learning processing and inference processing using a machine learning model. As the graphic processing device 10b, various arithmetic processing devices, for example, an integrated circuit (IC) such as a graphics processing unit (GPU), an APU, a DSP, an ASIC, or an FPGA are exemplified.

The memory 10c is an example of HW that stores information such as various types of data and programs. As the memory 10c, for example, one or both of a volatile memory such as a dynamic random access memory (DRAM) and a nonvolatile memory such as a persistent memory (PM) are exemplified.

The storage unit 10d is an example of HW that stores information such as various types of data and programs. As the storage unit 10d, various storage devices such as a magnetic disk device such as a hard disk drive (HDD), a semiconductor drive device such as a solid state drive (SSD), and a nonvolatile memory are exemplified. As the nonvolatile memory, for example, a flash memory, a storage class memory (SCM), a read only memory (ROM), and the like are exemplified.

The storage unit 10d may store a program 10h (data augmentation program) that implements all or a part of various functions of the computer 10.

For example, the processor 10a of the data augmentation apparatus 1 may implement a data augmentation function to be described later by developing the program 10h stored in the storage unit 10d in the memory 10c and executing the program 10h. Furthermore, the storage unit 10d may store various types of data generated in a process of processing by each unit (see FIG. 1) that implements the function as the data augmentation apparatus 1.

The IF unit 10e is an example of a communication IF that performs control of coupling and communication between the present computer 10 and another computer, and the like. For example, the IF unit 10e may include an adapter conforming to a local area network (LAN) such as Ethernet (registered trademark), optical communication such as a fibre channel (FC), or the like. The adapter may support one or both of wireless and wired communication systems.

For example, the data augmentation apparatus 1 may be coupled to another information processing device (not illustrated) via the IF unit 10e and a network so as to be able to communicate with each other. Note that the program 10h may be downloaded from the network to the computer 10 via the communication IF and stored in the storage unit 10d.

The IO unit 10f may include one or both of an input device and an output device. As the input device, for example, a keyboard, a mouse, a touch panel, and the like are exemplified. As the output device, for example, a monitor, a projector, a printer, and the like are exemplified. Furthermore, the IO unit 10f may include a touch panel or the like in which the input device and a display device are integrated. The output device may be coupled to the graphic processing device 10b.

The reading unit 10g is an example of a reader that reads information regarding data and programs recorded in a recording medium 10i. The reading unit 10g may include a coupling terminal or a device to which the recording medium 10i may be coupled or inserted. As the reading unit 10g, for example, an adapter conforming to a universal serial bus (USB) or the like, a drive device that accesses a recording disk, a card reader that accesses a flash memory such as a secure digital (SD) card, and the like are exemplified. Note that the program 10h may be stored in the recording medium 10i, and the reading unit 10g may read the program 10h from the recording medium 10i and store the program 10h in the storage unit 10d.

As the recording medium 10i, for example, a non-transitory computer-readable recording medium such as a magnetic/optical disk or a flash memory is exemplified. As the magnetic/optical disk, for example, a flexible disk, a compact disc (CD), a digital versatile disc (DVD), a Blu-ray disc, a holographic versatile disc (HVD), and the like are exemplified. As the flash memory, for example, a USB memory and a semiconductor memory such as an SD card are exemplified.

The HW configuration of the computer 10 described above is an example. Therefore, an increase or decrease in the HW (for example, addition or deletion of an optional block), division, integration in an optional combination, addition or deletion of the bus, or the like in the computer 10 may be appropriately performed.

As illustrated in FIG. 1, for example, the data augmentation apparatus 1 may include functions as a base artificial data generation unit 101, a collation unit 102, a data tendency extraction unit 103, an artificial data optimization unit 104, and an end determination unit 105. These functions may be implemented by the hardware of the computer 10 (see FIG. 4).

The base artificial data generation unit 101 generates base artificial data (base data) serving as a base of artificial data generated by the present data augmentation apparatus 1. The base artificial data generation unit 101 generates the base artificial data belonging to a minority group class.

Information regarding the minority group class and external statistical information are input to the base artificial data generation unit 101. Information regarding a plurality of pieces of existing data may be input to the base artificial data generation unit 101. The base artificial data generation unit 101 may acquire the information regarding the minority group class, the external statistical information, and the plurality of pieces of existing data by reading the information regarding the minority group class and the external statistical information stored in a predetermined storage area of the storage unit 10d. The plurality of pieces of existing data may be referred to as an existing data set.

In the base artificial data generation unit 101, processing of acquiring existing data (first plurality of pieces of data) and external statistical information (statistical information) regarding a plurality of attributes included in each piece of the existing data is implemented.

The base artificial data belonging to the minority group class may be referred to as minority group class artificial data. The base artificial data generation unit 101 may generate a plurality of pieces of base artificial data.

The base artificial data generation unit 101 determines the number N of pieces of base artificial data to be generated based on the external statistical information. Note that it is assumed that the number of males is N1 and the number of females is N2 among the number N of pieces of base artificial data to be generated. N=N1+N2 is satisfied.

In the following example, an example will be indicated in which the data augmentation apparatus 1 generates artificial data based on the existing data set exemplified in FIG. 2 and the external statistical information exemplified in FIGS. 3A to 3D. Furthermore, it is assumed that an age group of 60 years of age or older is the minority group class, and the data augmentation apparatus 1 generates artificial data belonging to this class of 60 years of age or older as the minority group class.

For example, the base artificial data generation unit 101 acquires each of a ratio x1 of males 60 years of age or older (x1=25.6% in the example illustrated in FIG. 3C) and a ratio x2 of males under 60 years of age (x2=74.4% in the example illustrated in FIG. 3C) based on the external statistical information regarding the population distribution (see FIG. 3C).

Furthermore, the base artificial data generation unit 101 acquires the number a1 of males 60 years of age or older in the existing data set (a1=0 in the example illustrated in FIG. 2) and the number a2 of males under 60 years of age in the existing data set (a2=4 in the example illustrated in FIG. 2).

Then, the base artificial data generation unit 101 calculates N1 such that (a1+N1):a2=x1:x2, thereby determining the number N1 of pieces of base artificial data of males to be generated. In the examples illustrated in FIGS. 2 and 3C, N1=1.38≈2. The base artificial data generation unit 101 determines to generate two pieces of base artificial data of males 60 years of age or older.

Similarly, the base artificial data generation unit 101 acquires each of a ratio y1 of females 60 years of age or older (y1=31.5% in the example illustrated in FIG. 3C) and a ratio y2 of females under 60 years of age (y2=68.5% in the example illustrated in FIG. 3C) based on the external statistical information regarding the population distribution (see FIG. 3C).

Furthermore, the base artificial data generation unit 101 acquires the number b1 of females 60 years of age or older in the existing data set (b1=1 in the example illustrated in FIG. 2) and the number b2 of females under 60 years of age in the existing data set (b2=3 in the example illustrated in FIG. 2).

Then, the base artificial data generation unit 101 calculates N2 such that (b1+N2):b2=y1:y2, thereby determining the number N2 of pieces of base artificial data of females to be generated.

In the examples illustrated in FIGS. 2 and 3C, N2=0.38≈1. The base artificial data generation unit 101 determines to generate one piece of base artificial data of females 60 years of age or older.

The base artificial data generation unit 101 generates base artificial data in the calculated number (N) of pieces of base artificial data. In the examples illustrated in FIGS. 2 and 3C, the base artificial data generation unit 101 generates entries of base artificial data for a total of three persons (N=3) including two males and one female. In initial values of the base artificial data, each attribute value included in each entry may be blank.

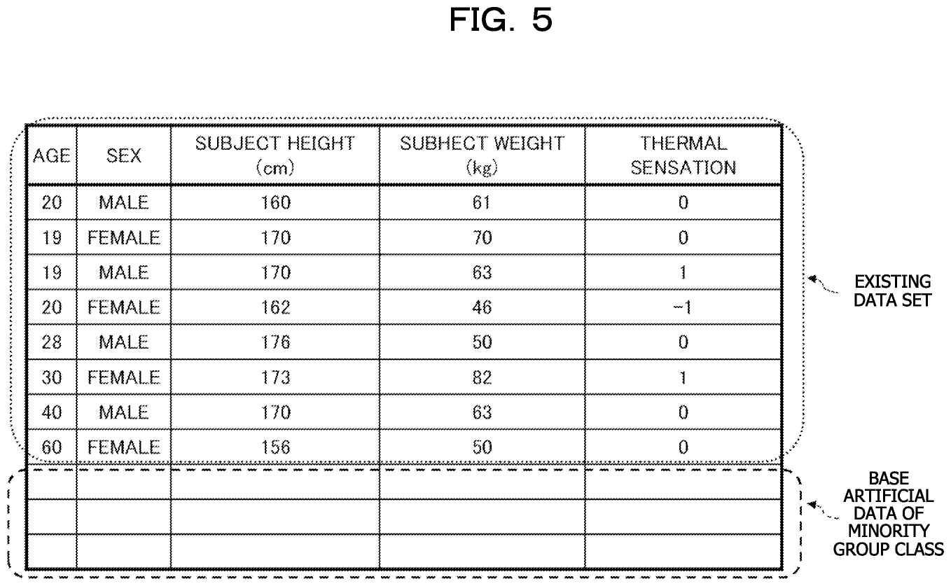

FIG. 5 is a diagram for describing processing of the base artificial data generation unit 101 of the data augmentation apparatus 1 as an example of the embodiment. In the example illustrated in this FIG. 5, the existing data set and the base artificial data of the minority group class generated by the base artificial data generation unit 101 are illustrated.

The base artificial data exemplified in this FIG. 5 includes the two entries for the males 60 years of age or older and the one entry for the female 60 years of age or older. Furthermore, each attribute value of each entry may be blank. Hereinafter, for convenience, the entry of the base artificial data may be simply referred to as the base artificial data.

The base artificial data generation unit 101 stores information for constituting the generated base artificial data in a predetermined storage area of the storage unit 10d.

The base artificial data generation unit 101 artificially generates and sets attribute values of the age (Age) and the sex (Sex) for each entry of the generated base artificial data.

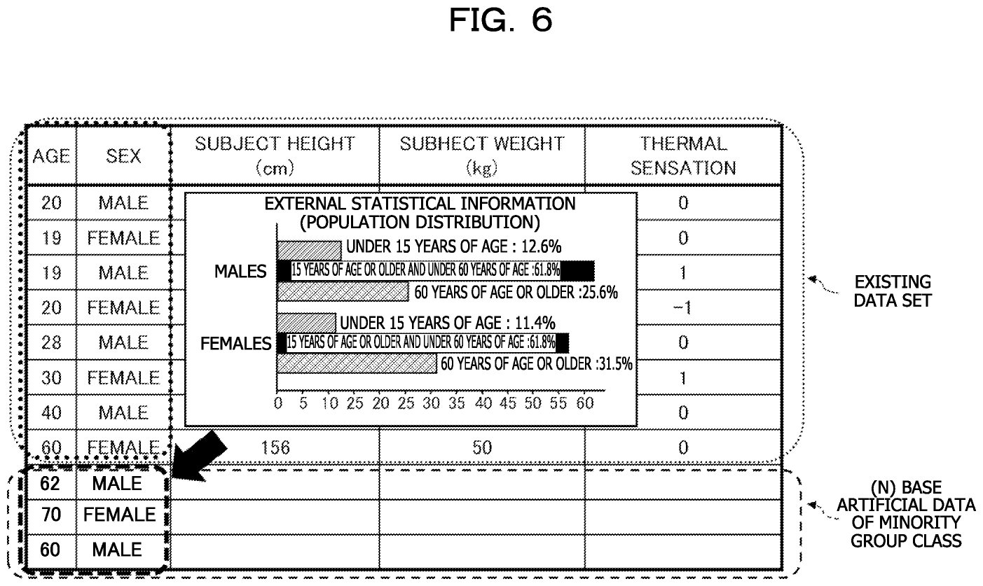

FIG. 6 is a diagram for describing the processing of the base artificial data generation unit 101 of the data augmentation apparatus 1 as an example of the embodiment. In the example illustrated in this FIG. 5, a state is indicated where the attribute values of the age (Age) and the sex (Sex) are set for the base artificial data generated by the base artificial data generation unit 101.

The base artificial data generation unit 101 sets male (Male) as the sex (Sex) in the entries of the base artificial data corresponding to the calculated number N1 of pieces of base artificial data of males (N1=2 in the example illustrated in FIG. 6) among the generated base artificial data.

Furthermore, the base artificial data generation unit 101 sets female (Female) as the sex (Sex) in the entry of the base artificial data corresponding to the calculated number N2 of pieces of base artificial data of females (N2=1 in the example illustrated in FIG. 6) among the generated base artificial data.

Moreover, the base artificial data generation unit 101 randomly generates a value of 60 or more for each piece of the generated base artificial data, and sets the value as the age (Age). For this age, it is desirable to set an upper limit value (for example, 100) based on, for example, external statistical information regarding a life (not illustrated), or the like. Furthermore, as a value of the age is smaller (closer to 60), an appearance probability may be increased.

Next, the base artificial data generation unit 101 artificially generates and sets attribute values of the height (Subject height) and the weight (Subject weight) for each entry of the generated base artificial data.

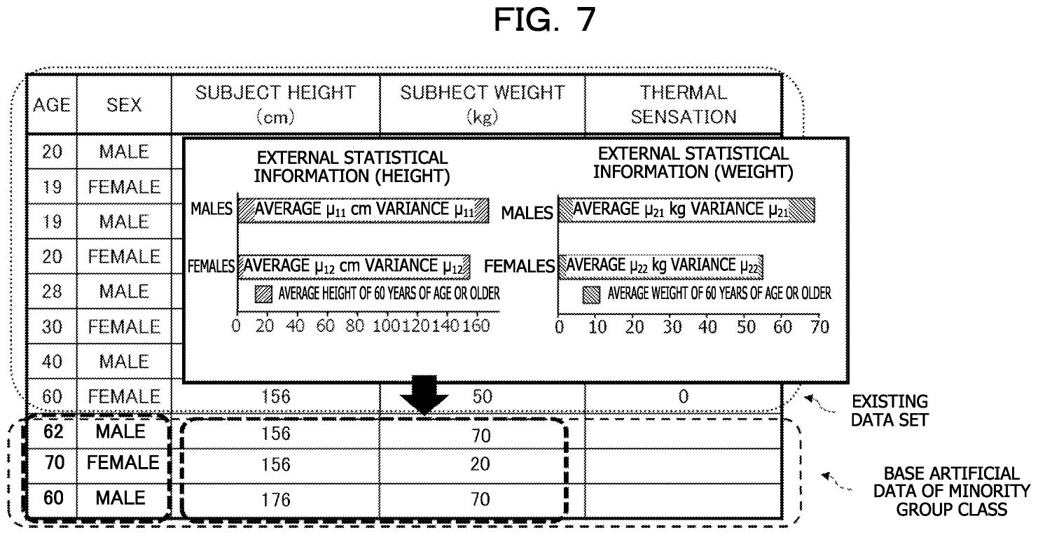

FIG. 7 is a diagram for describing the processing of the base artificial data generation unit 101 of the data augmentation apparatus 1 as an example of the embodiment. In the example illustrated in this FIG. 7, a state is indicated where the attribute values of the height (Subject height) and the weight (Subject weight) are set for the artificial data generated by the base artificial data generation unit 101.

The base artificial data generation unit 101 determines and sets values of the height for the entries of the base artificial data corresponding to the calculated number N1 of pieces of base artificial data of the males among the generated base artificial data, based on the external statistical information regarding the height and the weight of males (average value and variance of the height, average value and variance of the weight).

The base artificial data generation unit 101 uses, for example, values randomly generated within a range indicated by a value of the variance based on the average height of males in the external statistical information as the values of the height to be set in the base artificial data.

Furthermore, the base artificial data generation unit 101 uses, for example, values randomly generated within a range indicated by a value of the variance based on the average weight of males in the external statistical information as the values of the weight to be set in the base artificial data.

Similarly, the base artificial data generation unit 101 determines and sets a value of the weight for the entry of the base artificial data corresponding to the calculated number N2 of pieces of base artificial data of females among the generated base artificial data, based on the external statistical information regarding the height and the weight of females (average value and variance of the height, average value and variance of the weight).

The base artificial data generation unit 101 uses, for example, a value randomly generated within a range indicated by a value of the variance based on the average height of females in the external statistical information as the value of the height to be set in the base artificial data.

Furthermore, the base artificial data generation unit 101 uses, for example, a value randomly generated within a range indicated by a value of the variance based on the average weight of females in the external statistical information as the value of the weight to be set in the base artificial data.

The values of the height and the weight set for the base artificial data by the base artificial data generation unit 101 are updated and optimized by the artificial data optimization unit 104 to be described later. Each value (attribute value) of the height and the weight set for the base artificial data by the base artificial data generation unit 101 may be referred to as a base attribute value.

Next, the base artificial data generation unit 101 artificially generates and sets an attribute value of the thermal sensation (Thermal sensation) for each entry of the generated base artificial data.

The base artificial data generation unit 101 may use a value randomly generated within a range (−3 to +3 in the example illustrated in FIG. 3D) indicated by the external statistical information regarding the thermal sensation as the value of the thermal sensation to be set in the base artificial data for each piece of the generated base artificial data.

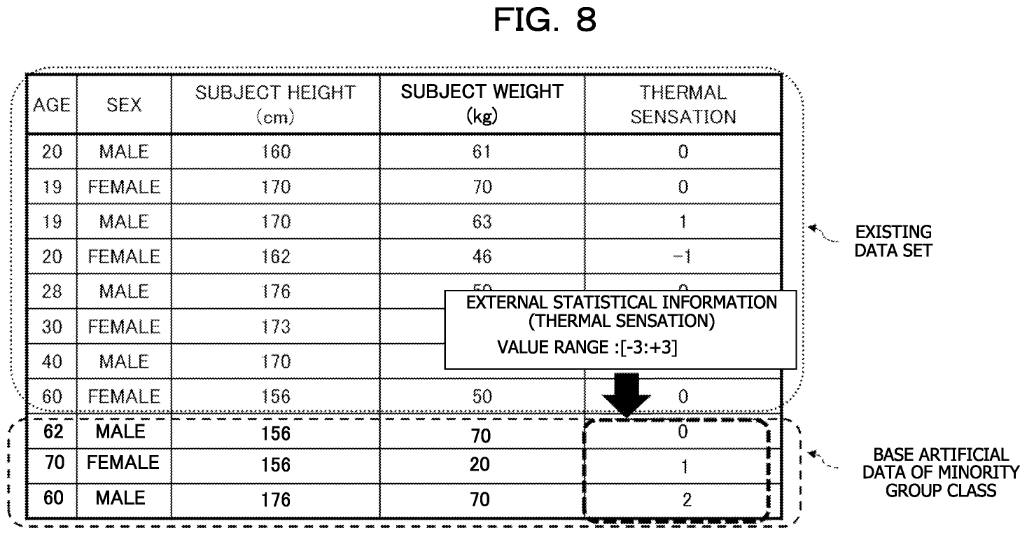

FIG. 8 is a diagram for describing the processing of the base artificial data generation unit 101 of the data augmentation apparatus 1 as an example of the embodiment. In the example illustrated in this FIG. 8, a state is indicated where the attribute value of the thermal sensation (Thermal sensation) is set for the artificial data generated by the base artificial data generation unit 101.

The thermal sensation is a value in a public database, and a value range is determined to be [−3: +3]. In an existing method, external statistical data is not considered, and a thermal sensation attribute value is generated by a random number, so that a contradicting value (−3=cold) is generated.

On the other hand, in the present data augmentation apparatus 1, the statistical information regarding the thermal sensation attribute values of 60 years of age or older is acquired from the existing data set, and the artificial data is generated according to the statistical information. Therefore, for example, for the thermal sensation having a normal data distribution range of −1 to +1, a contradictory value such as −3 is not generated.

The collation unit 102 collates the base artificial data generated by the base artificial data generation unit 101 with the external statistical information, and extracts (calculates) an error between the base artificial data and the external statistical information.

For an attribute Xi of the artificial data, in a case where an average given by the external statistical information is represented by a reference sign X⁻ᵢ and the base artificial data is represented by a reference sign xᵢⱼ, a standard error SEᵢ is represented by the following Expression (1).

$$[ Expression 1 ]$$

$$standard error {SE}_{i} = \frac{{s}_{i}}{\sqrt{N}} \\ Here , \\ {s}_{i} = \sqrt{\frac{1}{N - 1} {\sum }_{j = 1}^{N} {( {x}_{ij} - {\overline{X}}_{i} )}^{2}} \qquad ( 1 )$$

is satisfied.

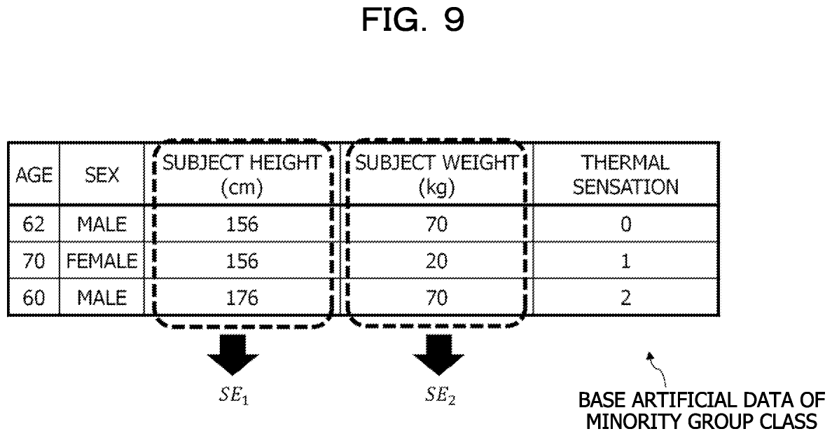

FIG. 9 is a diagram for describing processing of the collation unit 102 of the data augmentation apparatus 1 as an example of the embodiment.

In the example illustrated in this FIG. 9, a standard error SE₁ is calculated based on each attribute value of the height (Subject height) in the base artificial data generated by the base artificial data generation unit 101. Furthermore, a standard error SE₂ is calculated based on each attribute value of the weight (Subject weight) in the base artificial data.

Furthermore, the collation unit 102 calculates a sum total ΣSEᵢ of errors (standard errors) SEᵢ for each attribute i between the base artificial data and the external statistical information.

In the example illustrated in this FIG. 9, a sum (SE₁+SE₂) of the standard error SE₁ calculated based on each attribute value of the height (Subject height) in the base artificial data and the standard error SE₂ calculated based on each attribute value of the weight (Subject weight) in the base artificial data is the sum total ΣSEᵢ of the errors for each attribute i between the base artificial data and the external statistical information. The sum total ΣSEᵢ of the errors may be represented as ΣSE for convenience.

Note that, in the example illustrated in FIG. 9, the collation unit 102 may calculate a standard error SE₃ based on each attribute value of the thermal sensation (Thermal sensation) in the base artificial data. Furthermore, the collation unit 102 may add the standard error SE₃ calculated based on each attribute value of the thermal sensation (Thermal sensation) to the sum total ΣSEᵢ of the errors for each attribute i between the base artificial data and the external statistical information.

The collation unit 102 stores the calculated sum total ΣSE of the errors in a predetermined storage area of the storage unit 10d.

The data tendency extraction unit 103 extracts a data tendency change ΣΔr in a case where data augmentation is performed on the existing data by adding the base artificial data to the existing data. The plurality of pieces of existing data (existing data set) is input to the data tendency extraction unit 103. The data tendency extraction unit 103 may acquire the existing data set by reading the existing data set stored in a predetermined storage area of the storage unit 10d.

A correlation between an attribute Xᵢ and an attribute Xⱼ of the existing data set is represented as R_{XiXj}.

The data tendency extraction unit 103 specifies, based on values of the plurality of attributes included in each piece in the existing data set (first plurality of pieces of data), a relationship between the attributes in the existing data set (first plurality of pieces of data).

A variation Δr of a correlation coefficient is represented by the following Expression (2).

Δr=r′_{XiXj}−r_{XiXj} (2)

Here, r_{XiXj} is a correlation coefficient of the existing data set, and r′_{XiXj} is a correlation coefficient in a state where data augmentation is performed by adding the base artificial data to the existing data set.

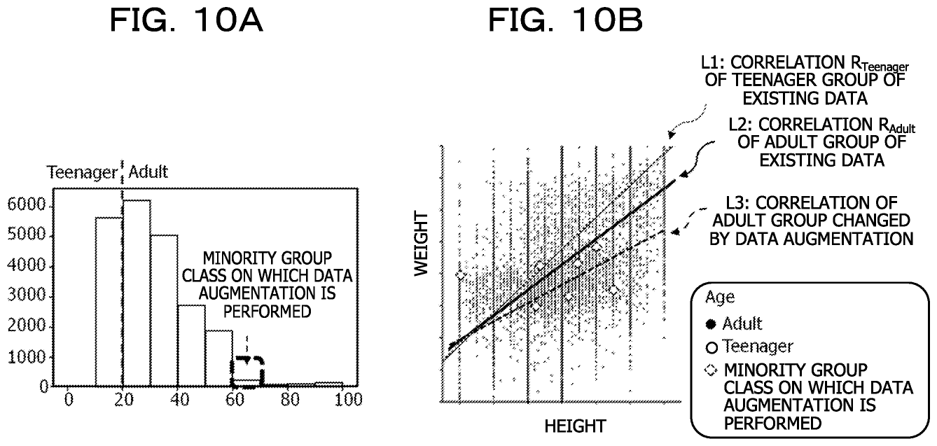

FIGS. 10A and 10B are diagrams for describing processing of the data tendency extraction unit 103 in the data augmentation apparatus 1 as an example of the embodiment.

FIG. 10A exemplifies a data distribution for each age group, in which a horizontal axis indicates the age group and a vertical axis indicates the number of pieces of data. Furthermore, in the example illustrated in this FIG. 10A, the data distribution in the state where data augmentation is performed by adding the base artificial data to the existing data is illustrated, and an example in which the base artificial data regarding people in their 60s as the minority group class is added to the existing data is illustrated.

Furthermore, FIG. 10B exemplifies correlations between the height and the weight of a teenager group (under 20 years of age) and an adult group (20 years of age or older), in which a horizontal axis indicates the height and a vertical axis indicates the weight.

In the example illustrated in this FIG. 10B, a straight line indicated by denoting a reference sign L1 indicates the correlation between the height and the weight of the teenager group of the existing data. This correlation between the height and the weight of the teenager group of the existing data may be represented as R_{Teenager}.

Furthermore, a straight line indicated by denoting a reference sign L2 indicates the correlation between the height and the weight of the adult group of the existing data. This correlation between the height and the weight of the adult group of the existing data may be represented as R_{Adult} Moreover, a straight line indicated by denoting a reference sign L3 indicates the correlation between the height and the weight of the adult group changed by the data augmentation.

The artificial data optimization unit 104 optimizes the base artificial data based on a condition that the data tendency change ΣΔr calculated by the data tendency extraction unit 103 is reduced.

The artificial data optimization unit 104 may perform the optimization by updating the attribute value of the base artificial data, and implement the optimization by, for example, repeatedly changing at least one value of the height and the weight in the base artificial data by a predetermined amount.

For example, the artificial data optimization unit 104 may repeatedly perform update to increase or decrease the value of the height in the base artificial data by 1 cm, or may repeatedly perform update to increase or decrease the value of the weight by 1 kg.

Furthermore, the artificial data optimization unit 104 may perform the optimization by updating one of the values of the height and the weight in the base artificial data, or may perform the optimization by updating both the values of the height and the weight.

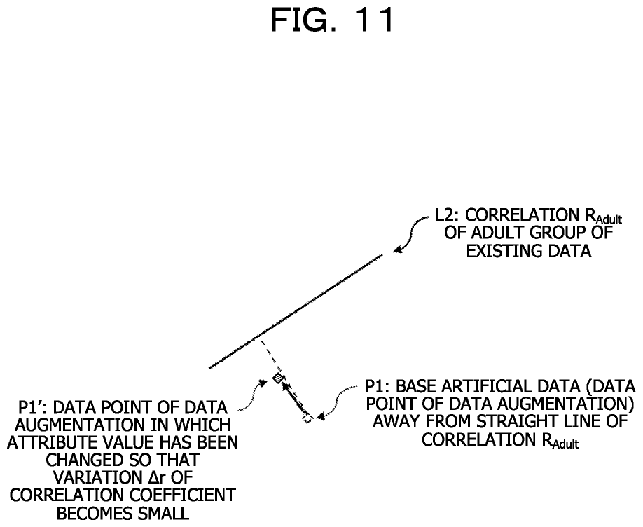

FIG. 11 is a diagram for describing a method of optimizing the base artificial data by the artificial data optimization unit 104 of the data augmentation apparatus 1 as an example of the embodiment.

FIG. 11 illustrates the straight line L2 indicating the correlation R_{Adult} between the height and the weight of the adult group of the existing data illustrated in FIG. 10B, base artificial data P1 used as data augmentation, and base artificial data P1′ after the update in which the attribute value has been changed by performing optimization on the base artificial data P1.

The artificial data optimization unit 104 generates the base artificial data P1′ after the update by updating the attribute value so that the variation Δr of the correlation coefficient becomes small for the base artificial data P1.

The artificial data optimization unit 104 generates the base artificial data P1′ after the update by, for example, updating at least one of the values of the height and the weight in the base artificial data P1.

The artificial data optimization unit 104 updates the values of the plurality of attributes included in the base artificial data based on a condition that the data tendency change (ΣΔr) due to data augmentation performed by adding the base artificial data (base data) including the plurality of attributes same as that in the existing data set to the existing data set (first plurality of pieces of data) is reduced.

This update is executed based on a condition that the sum total ΣSE of the standard errors SE for each of the plurality of attributes between the base artificial data and the external statistical information is reduced.

It may be said that the artificial data optimization unit 104 generates the artificial data based on the existing data set (first plurality of pieces of data), the external statistical information, and the relationship between the attributes in the existing data set.

The end determination unit 105 determines whether or not to end the optimization for the base artificial data.

Minimization of the sum total ΣSEᵢ of the standard errors SEᵢ means minimization of the errors between the base artificial data and the external statistical information. Furthermore, minimization of the data tendency change ΣΔr means minimization of unnaturalness caused by data augmentation of the existing data using the base artificial data.

The end determination unit 105 obtains, by using a multi-objective optimization method, an optimum solution between an objective function min(ΣSE) that minimizes ΣSE and an objective function min(ΣΔr) that minimizes ΣΔr.

As a result of the change in the artificial data by the artificial data optimization unit 104 described above, the value of the data tendency change (ΣΔr) decreases, but ΣSE increases. The end determination unit 105 determines a point that satisfies both min(ΣSE) and min(ΣΔr) as the optimum solution.

Note that, as a method of solving a multi-objective optimization problem, various known methods may be used, and the description thereof will be omitted.

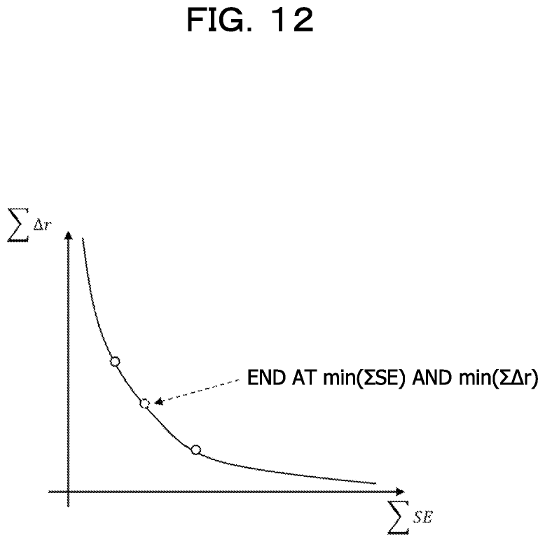

FIG. 12 is a diagram for describing processing of the artificial data optimization unit 104 of the data augmentation apparatus 1 as an example of the embodiment.

In this FIG. 12, a graph of a multi-objective optimization function for simultaneously obtaining the objective function min(ΣSE) and the objective function min(ΣΔr) in a coordinate space in which a horizontal axis is ΣSE and a vertical axis is ΣΔr is illustrated. In an initial value, ΣSE indicates a minimum value when ΣΔr is the maximum.

The end determination unit 105 determines whether both ΣSE and ΣΔr are minimized, for example, whether the objective function min(ΣSE) and the objective function min(ΣΔr) are satisfied.

In a case where both ΣSE and ΣΔr are minimized, the end determination unit 105 ends the optimization of the base artificial data by the artificial data optimization unit 104. The base artificial data optimized by the artificial data optimization unit 104 is used as training data of a machine learning model as the augmentation data (artificial data, second data) for the existing data.

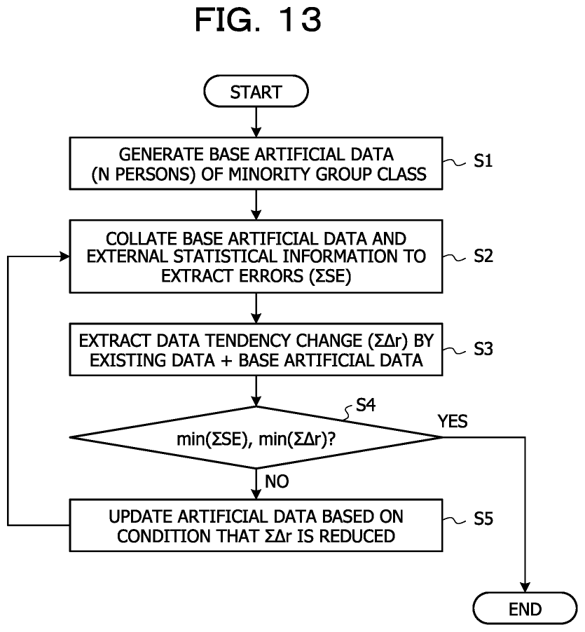

Processing of the data augmentation apparatus 1 as an example of the embodiment configured as described above will be described with reference to a flowchart (Steps S1 to S5) illustrated in FIG. 13.

In Step S1, the base artificial data generation unit 101 generates base artificial data for N persons belonging to a minority group class. The base artificial data generation unit 101 determines the number N of pieces of base artificial data to be generated based on external statistical information. Furthermore, the base artificial data generation unit 101 sets base attribute values (height, weight, thermal sensation) for the generated base artificial data.

In Step S2, the collation unit 102 calculates (extracts) a sum total ΣSE of errors for each attribute between the base artificial data and the external statistical information.

In Step S3, the data tendency extraction unit 103 calculates (extracts) a data tendency change ΣΔr in a case where data augmentation is performed on existing data by adding the base artificial data to the existing data.

In Step S4, the end determination unit 105 confirms whether both ΣSE and ΣΔr are minimized, for example, whether an objective function min(ΣSE) and an objective function min(ΣΔr) are obtained.

As a result of the confirmation, in a case where at least one of ΣSE and ΣΔr is not minimized (see a NO route of Step S4), the processing proceeds to Step S5.

In Step S5, the artificial data optimization unit 104 updates the base artificial data based on a condition that ΣΔr is reduced. Thereafter, the processing returns to Step S2.

As a result of the confirmation in Step S4, in a case where the end determination unit 105 determines that both ΣSE and ΣΔr are minimized, for example, the objective function min(ΣSE) and the objective function min(ΣΔr) are obtained (see a YES route in Step S4), the processing ends.

In this way, according to the data augmentation apparatus 1 as an example of the embodiment, the collation unit 102 collates the base artificial data having the base attribute values, which is generated by the base artificial data generation unit 101, with the external statistical information, and calculates the sum total ΣSE of the standard errors for each attribute between the base artificial data and the external statistical information.

Furthermore, the data tendency extraction unit 103 calculates (extracts) the data tendency change ΣΔr in a case where data augmentation is performed on the existing data by adding the base artificial data to the existing data.

Then, the artificial data optimization unit 104 optimizes the base artificial data so as to satisfy the objective function min(ΣSE) and the objective function min(ΣΔr).

For example, the artificial data optimization unit 104 minimizes the errors (ΣSE) between the base artificial data, which is a source of the artificial data used for the data augmentation, and the external statistical information. Furthermore, the artificial data optimization unit 104 updates the attribute values of the base artificial data based on the condition that the variation ΣΔr of the data tendency caused by adding the base artificial data to the existing data and performing the data augmentation is reduced.

With this configuration, when the data augmentation of the minority group class not included in the existing data set using the external statistical information is performed, it is possible to suppress generation of unnatural artificial data while bringing the base artificial data close to the external statistical information as much as possible. Note that the unnatural artificial data includes data in which there is a contradiction between the attribute values and data in which there is a contradiction in the data distribution of the existing data.

A nature of naturalness of data is included in the existing data. By the artificial data optimization unit 104 updating the attribute values of the base artificial data based on the condition that the variation ΣΔr of the data tendency caused by adding the base artificial data to the existing data and performing the data augmentation is reduced, it is possible to remove unnaturalness from the artificial data to be generated. With this configuration, even in a case where the data augmentation of the minority group class is performed by using the artificial data, it is possible to generate natural training data.

Furthermore, in a case where the data augmentation of the minority group class is performed by using the artificial data, it is possible to minimize a model change due to the data tendency change and reduce an influence of the data augmentation.

Each configuration and each processing of the present embodiment may be selected or omitted as needed or may be appropriately combined.

Additionally, the disclosed technology is not limited to the embodiment described above, and various modifications may be made and performed in a range without departing from the spirit of the present embodiment.

For example, in the embodiment described above, the example has been indicated in which the data indicating the thermal sensation in the office at the temperature of 24° C. is generated as the artificial data, but the embodiment is not limited to this, and may be appropriately changed and performed.

Furthermore, the present embodiment may be performed and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data augmentation program for causing a computer to execute processing comprising:
acquiring a first plurality of pieces of data and statistical information regarding a plurality of attributes included in each of the first plurality of pieces of data;
specifying a relationship between the attributes in the first plurality of pieces of data based on values of the plurality of attributes included in each of the first plurality of pieces of data; and
generating data based on the first plurality of pieces of data, the statistical information, and the relationship between the attributes in the first plurality of pieces of data.

2. The non-transitory computer-readable recording medium according to claim 1, wherein
the processing of generating the data includes processing of updating, based on a condition that a data tendency change due to data augmentation performed by adding base data that includes the plurality of attributes to the first plurality of pieces of data is reduced, the values of the plurality of attributes included in the base data, and
the data is base data after the update.

3. The non-transitory computer-readable recording medium according to claim 2, wherein the processing of updating is executed based on a condition that a sum total of standard errors for each of the plurality of attributes between the base data and the statistical information is reduced.

4. The non-transitory computer-readable recording medium according to claim 1, for causing the computer to execute the processing further comprising determining the number of pieces of the data to be generated based on the statistical information.

5. A data augmentation method comprising:
acquiring a first plurality of pieces of data and statistical information regarding a plurality of attributes included in each of the first plurality of pieces of data;
specifying a relationship between the attributes in the first plurality of pieces of data based on values of the plurality of attributes included in each of the first plurality of pieces of data; and
generating data based on the first plurality of pieces of data, the statistical information, and the relationship between the attributes in the first plurality of pieces of data.

6. The data augmentation method according to claim 5, wherein
the processing of generating the data includes processing of updating, based on a condition that a data tendency change due to data augmentation performed by adding base data that includes the plurality of attributes to the first plurality of pieces of data is reduced, the values of the plurality of attributes included in the base data, and
the data is base data after the update.

7. The data augmentation method according to claim 6, wherein the processing of updating is executed based on a condition that a sum total of standard errors for each of the plurality of attributes between the base data and the statistical information is reduced.

8. The data augmentation method according to claim 5, for causing the computer to execute the processing further comprising determining the number of pieces of the data to be generated based on the statistical information.

9. A data augmentation apparatus comprising:
a memory; and
a processor coupled to the memory and configured to:
acquire a first plurality of pieces of data and statistical information regarding a plurality of attributes included in each of the first plurality of pieces of data;
specify a relationship between the attributes in the first plurality of pieces of data based on values of the plurality of attributes included in each of the first plurality of pieces of data; and
generate data based on the first plurality of pieces of data, the statistical information, and the relationship between the attributes in the first plurality of pieces of data.

10. The data augmentation apparatus according to claim 9, wherein
a processing to generate the data includes processing of updating, based on a condition that a data tendency change due to data augmentation performed by adding base data that includes the plurality of attributes to the first plurality of pieces of data is reduced, the values of the plurality of attributes included in the base data, and
the data is base data after the update.

11. The data augmentation apparatus according to claim 10, wherein a processing to update is executed based on a condition that a sum total of standard errors for each of the plurality of attributes between the base data and the statistical information is reduced.

12. The data augmentation apparatus according to claim 9, wherein the processor determines the number of pieces of the data to be generated based on the statistical information.
